(19) United States
(12) Patent Application Publication
(10) Pub. No.: US 2006/0078302 A1
(43) Pub. Date: Apr. 13, 2006

(54) Recording medium, and method and apparatus for reproducing data from the recording medium

(76) Inventors: Kang Soo Seo, Anyang-si (KR); Jea Yong Yoo, Seoul (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/244,164

(22) Filed: Oct. 6, 2005

(30) Foreign Application Priority Data
Oct. 6, 2004 (KR) 10-2004-0079447

(51) Int. Cl. H04N 5/76

(52) U.S. Cl. 386/95; 386/98

(57) ABSTRACT

A recording medium, and a method and apparatus for reproducing data from the recording medium are disclosed. A method for reproducing data of a recording medium in which a first title and a second title having different attributes are recorded, includes the steps of reproducing the first title using a first dedicated reproduction unit, and performing transition of reproducing from the first title to the second title by stopping operations of the first dedicated reproduction units and starting operations of a second dedicated reproduction units. Therefore, data of the recording medium can be effectively managed, resulting in greater convenience of use.

This application claims the benefit of Korean Patent Application No. 10-2004-0079447, filed on Oct. 6, 2004, which is hereby incorporated by reference as if fully set forth herein.

### BACKGROUND OF THE INVENTION

1. Field of the Invention

The present invention relates to a recording medium, and more particularly to a data reproduction method and apparatus for effectively reproducing data having different attributes recorded in the recording medium.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

In association with the above-mentioned situation, there has recently been developed an optical recording/reproducing device based on the BD international standard, but the BD international standard has not yet been completed, such that many limitations and obstacles to the development of the optical recording/reproducing device remain.

Particularly, the above-mentioned BD can record a plurality of data units having different attributes, for example, a first title wherein a movie compressed in an MPEG2 format is recorded, a second title wherein interactive information including movies executed by a Java program is recorded, a third title recorded by a Web-language.

However, a method and apparatus for reproducing the above-mentioned data (e.g., titles) having different attributes are not yet well known to those skilled in the art associated with the BD specification, such that many limitations and problems occur in developing a BD-based optical recording/reproducing device.

### SUMMARY OF THE INVENTION

Accordingly, the present invention is directed to a method and apparatus for reproducing data from a recording medium that substantially obviate one or more problems due to limitations and disadvantages of the related art.

An object of the present invention is to provide a method and apparatus for reproducing data from a recording medium in which data having different attributes is recorded, such that information classifying the data having different attributes is recorded in the recording medium, and the data recorded in the recording medium is reproduced using the information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reproducing data of a recording medium in which a first title and a second title having different attributes are recorded, includes the steps of reproducing the first title using a first dedicated reproduction unit, and performing transition of reproducing from the first title to the second title by stopping operations of the first dedicated reproduction units and starting operations of a second dedicated reproduction units.

In another aspect of the present invention, an apparatus for reproducing data of a recording medium in which an HDMV title and a Java title having different attributes are recorded, includes a playback control engine for reproducing a reproduction operation according to a static scenario recorded in the recording medium, a movie module for controlling the playback control engine according to a command for reproducing the HDMV title, a BDJ module for executing a Java program capable of reproducing the Java title, and controlling the playback control engine when a reproduction operation caused by the static scenario recorded in the recording medium is required, and a module manager for receiving an external control command, and controlling operations of the movie module and the BDJ module.

In a further aspect of the present invention, a recording medium includes a title record area in which a first title and a second title having different attributes are recorded, and a management file record area in which a first management file for reproducing the first title and a second management file for reproducing the second title are recorded, wherein the management file record area stores information for classifying the first title and the second title.

Preferably, the first title is an HDMV title, and the second title is a Java title.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1C are conceptual diagrams illustrating individual titles recorded in a recording medium (i.e., a BD-ROM) according to the present invention;

FIG. 2 is a conceptual diagram illustrating a file structure recorded in an optical disc acting as a recording medium and a relationship for reproducing data of the file structure according to the present invention;

FIG. 3 is a structural diagram illustrating a data record structure recorded in an optical disc according to the present invention;

FIGS. 4A and 4B are conceptual diagrams illustrating reproduction of titles and a transition relationship between titles according to the present invention;

FIGS. 5A and 5B are block diagrams illustrating an apparatus for reproducing data from a recording medium according to the present invention;

FIGS. 6A and 6B are conceptual diagrams illustrating a method for reproducing data from a recording medium, and operations when an HDMV title is transitioned to a Java title by a Jump command according to the present invention;

FIGS. 7A and 7B are conceptual diagrams illustrating a method for reproducing data from a recording medium, and operations when a Java title is transitioned to an HDMV title by a Jump command according to the present invention;

FIGS. 8A and 8B are conceptual diagrams illustrating a method for reproducing data from a recording medium, and operations when an HDMV title is transitioned to a Java title by a Call command according to the present invention;

FIGS. 9A and 9B are conceptual diagrams illustrating a method for reproducing data from a recording medium, and operations when a Java title is transitioned to an HDMV title by a Resume command according to the present invention;

FIG. 10 is a block diagram illustrating an apparatus for reproducing data from a recording medium, and more particularly, an apparatus for receiving/processing a user command according to the present invention;

FIG. 11 is a block diagram illustrating an apparatus for reproducing data from a recording medium, and more particularly, an apparatus for managing a graphic plan according to the present invention; and

FIGS. 12A and 12B are structural diagrams illustrating syntax information of an index file according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A method and apparatus for reproducing data from a recording medium will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all storage media, for example, an optical disc, and a magnetic tape, etc., according to various recording schemes. For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

The term “Title” is indicative of a reproduction unit interfacing with a user, and each title is linked to a specific object, such that a stream associated with a corresponding title recorded in a disc is reproduced according to a command or program stored in the object.

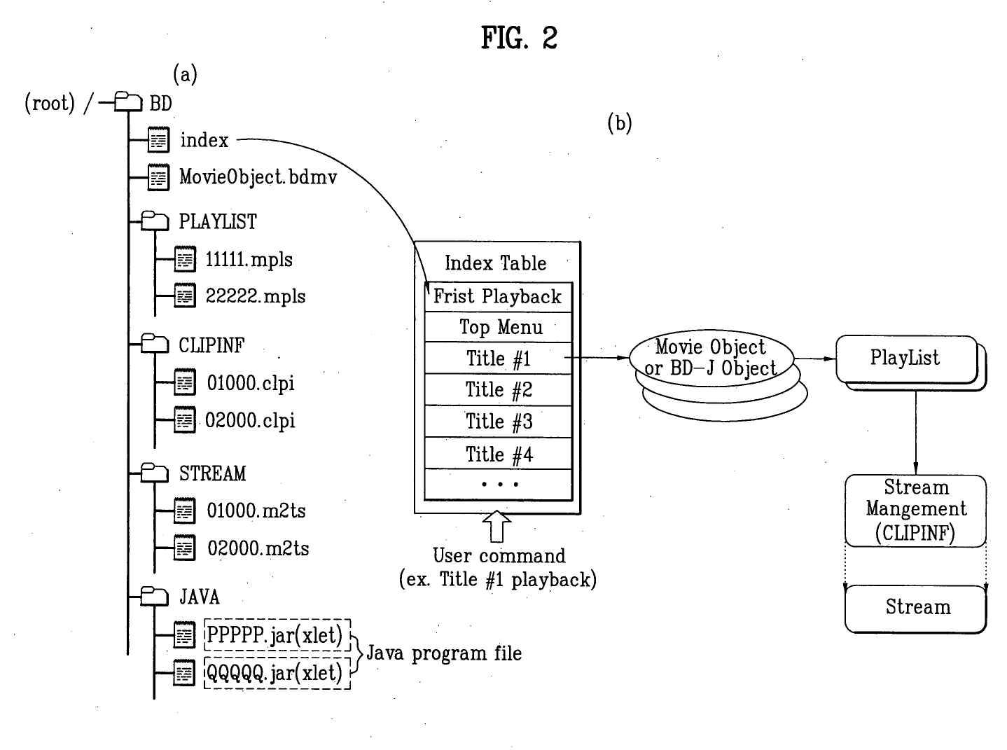

A title recorded in a disc and a disc file structure for reproducing the title will be described with reference to FIG. 2. Particularly, for the convenience of description and better understanding of the present invention, a first title in which movies and interactive information according to an MPEG2 compression scheme are recorded is called an HDMV title, and a second title in which movies and interactive information according to a Java program are recorded is called a Java title.

The term “Object” is indicative of reproduction management information including a command or program for reproducing the disc. In other words, a variety of objects present in a disc are linked to a specific title or are connected to other objects. Therefore, the above-mentioned objects are pre-designed according to intentions of a manufacturer or author of the disc, are recorded in the disc, and increase the number of scenarios for reproducing data of the disc. In association with the above-mentioned description, a plurality of objects may be present in a single file, or a single object may also be present in such a single file. Particularly, an object for reproducing the above-mentioned “HDMV title” will hereinafter be referred to as “Movie Object” or “M-OBJ”, and an object for reproducing the above-mentioned “Java Title” will hereinafter be referred to as “BD-J Object” or “Java Object”, or will also be referred to as “BDJ Object” or “BD-J OBJ”.

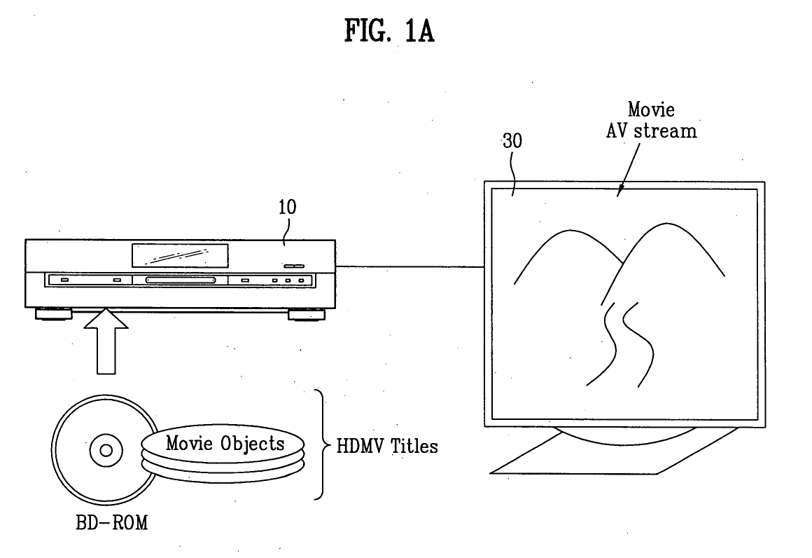

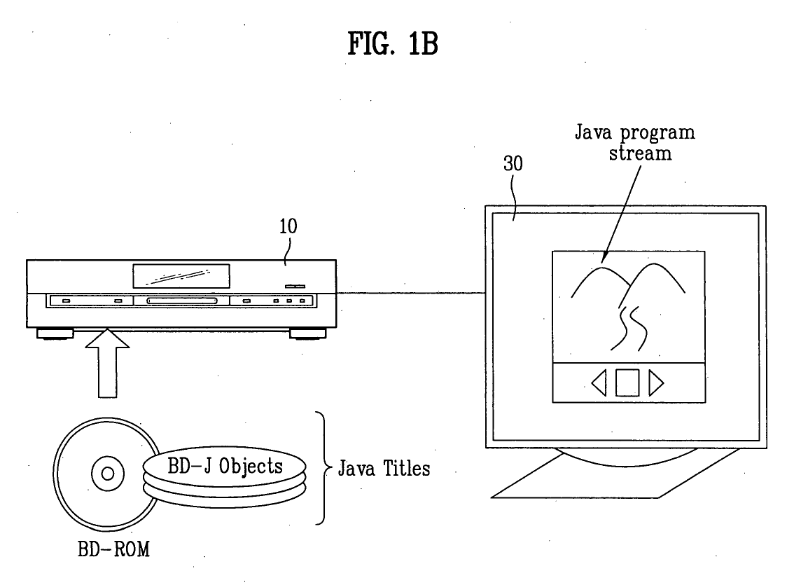

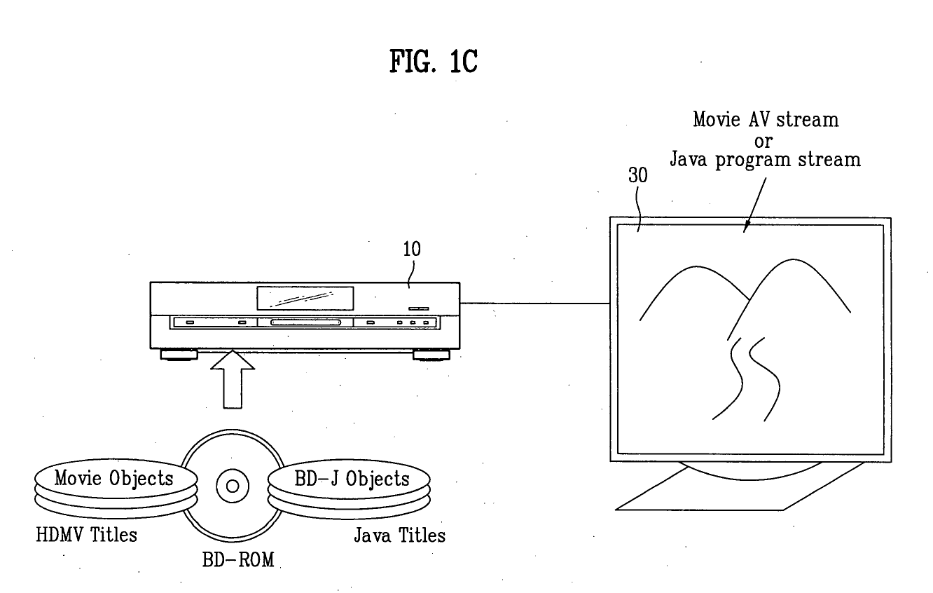

FIGS. 1A to 1C are conceptual diagrams illustrating individual titles recorded in a recording medium (e.g., a BD-ROM) according to the present invention. In more detail, FIGS. 1A to 1C show an example of a BD-ROM for use in an optical recording/reproducing device 10.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. Considering the BD standard and correlation with peripheral devices, the present invention uses either a BD-player capable of reproducing data from the BD or a BD-recorder for recording/reproducing data in/from the BD as a preferred embodiment for the convenience of description. It is well known in the art that the optical recording/reproducing device 10 is also applicable to a drive embedded in a specific device such as a computer.

The optical recording/reproducing device 10 reproduces data from the BD-ROM, reads data from the BD-ROM, performs a signal process and a decoding process on the read data according to attribute information of the read data, and transmits the signal processed result and the decoding result to a display 30 connected to the optical recording/reproducing device 10, such that a user can view the signal processed result and the decoding result on the display 30.

FIG. 1A shows a first case in which titles recorded in the BD-ROM are indicative of HDMV titles. FIG. 1B shows a second case in which titles recorded in the BD-ROM are indicative of Java titles. FIG. 1C shows a third case in which a title recorded in the BD-ROM is mixed with an HDMV title and a Java title, such that the title mixed with the HDMV and JAVA titles is recorded. The third case is referred to as a full mode.

The present invention provides a standardized disc file structure to reproduce data from the BD-ROM in the above-mentioned first, second, and third cases, and provides a player model acting as an apparatus for reproducing data from the BD-ROM.

FIG. 2 is a conceptual diagram illustrating a file structure (a) recorded in an optical disc such as a BD-ROM and a relationship (b) among files stored in the file structure (a) when reproducing a specific title from the file structure (a) according to the present invention.

The above-mentioned file structure (a) shown in FIG. 2 will hereinafter be described.

The management file structure (a) includes one or more BD directories in a single root directory. The BD directory includes not only an index file “index” acting as a general file (i.e., an upper file) capable of guaranteeing user interactivity, but also the above-mentioned object. The management file structure (a) includes a variety of directories for storing information of actual data recorded in a disc and other information associated with a method for reproducing the data, for example, a playlist directory (PLAYLIST), a clip information directory (CLIPINF), a stream directory (STREAM), and a java directory (JAVA). The above-mentioned directories and a variety of files included in the directory will hereinafter be described.

The stream directory (STREAM) includes a plurality of AV (Audio and Video) stream files recorded in a disc according to a specific format. For example, the stream directory (STREAM) uses extension names of stream files (01000.m2ts and 02000.m2ts) as a specific extension name “*.m2ts”. Generally, the stream file contains moving image data.

The clip information (Clip-info) directory (CLIPINF) is composed of a plurality of clip-info files (01000.clpi and 02000.clpi) connected to the above-mentioned stream files on a one-to-one basis. Particularly, the clip-info files (*.clpi) contain attribute information and timing information of the stream files therein. The clip-info files (*.clpi) connected to the stream files (*.m2ts) on a one-to-one basis are generically named a “Clip” in a BD standard. In other words, this means that a single stream file (*.m2ts) must correspond to a clip-info file (*.clpi).

The playlist directory (PLAYLIST) includes a plurality of playlist files (*.mpls). Each playlist file (*.mpls) includes one or more playitems (PlayItem) for designating a playing interval during which a specific clip is reproduced. The playitem (PlayItem) includes information associated with a specific clip to be reproduced, i.e., information associated with a reproduction start time (IN-Time) and other information associated with a reproduction termination time (OUT-Time) of a clip determined to be a clip name (Clip_Information_File_name) contained in the playitem (PlayItem).

The playlist file (*.mpls) is used as a basic management file unit contained in an overall management file structure, such that it can reproduce a desired clip using a combination of one or more playitems. The playlist file (*.mpls) may include data different from reproduction data formed by the playitem. Particularly, the playlist file (*.mpls) may include a sub-playitem (SubPlayItem) for reproducing auxiliary data.

The playlist file (*.mpls) is operated by a command or program of the above-mentioned object. From the viewpoint of a disc presentation scenario, the object executes or manages a dynamic scenario, and the playlist file (*.mpls) executes or manages a static scenario.

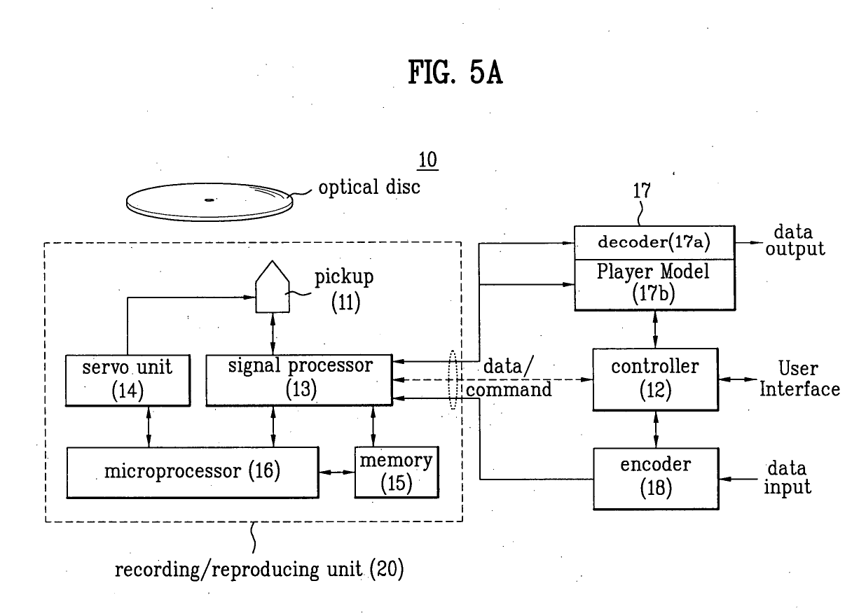

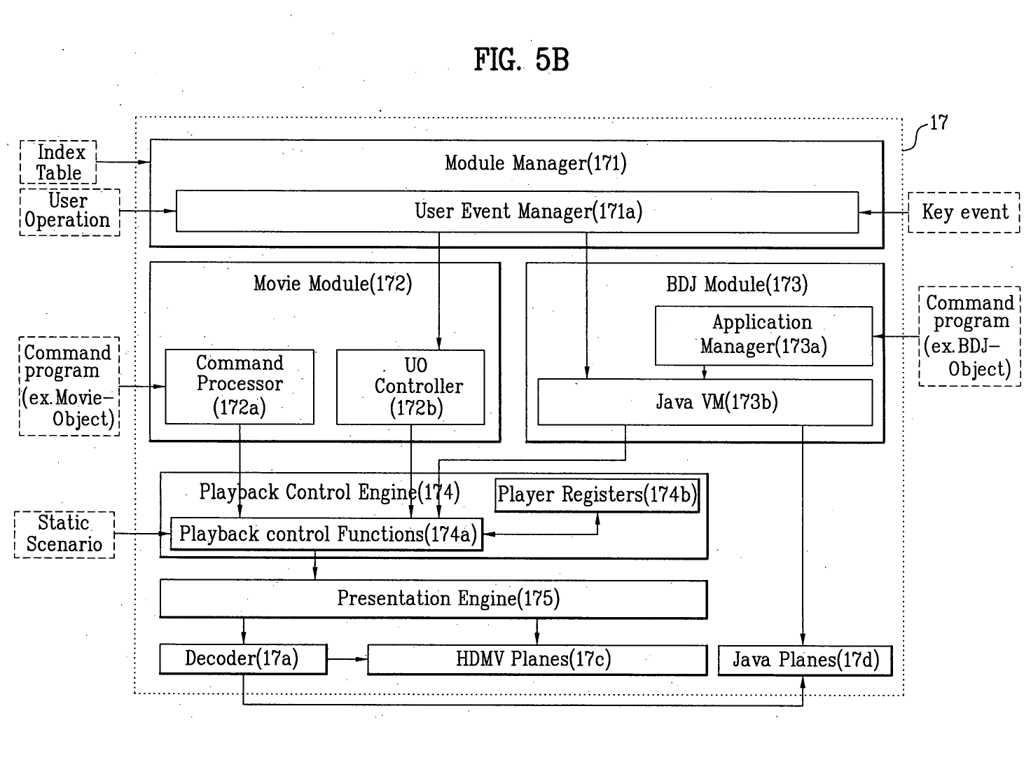

The Java directory (JAVA) records a plurality of Java program files (e.g., PPPPP.jar or QQQQQ.jar) therein. A variety of applications are programmed in individual Java program files, and each of the programmed applications may also be called an “Xlet”. In association with the above-mentioned description, the Java program file (*.jar) includes “BDJ Object” for executing the Java title. If a user desires to reproduce a specific Java title, a single Java program file including the above-mentioned “BDJ Object” is executed. The Java program files are executed by a dedicated reproduction device, and a detailed description thereof will be described later with reference to FIG. 5B.

The reference character (b) shown in FIG. 2 shows a relationship for reproducing a specific title using the above-mentioned file structure (a) of FIG. 2. Specifically, upon receiving a title reproduction command from a user in association with a specific title applied to an index table of an index file, the relationship for reproducing the specific title is described in FIG. 2(b).

If data of a corresponding disc is loaded, the index file includes first playback information “First Playback” indicative of information associated with a first reproduction image, top menu information “TopMenu” capable of providing a title recorded in a disc with a menu image, and at least one title information (e.g., Title #1˜Title #4). In more detail, the above-mentioned titles Title #1˜Title #4 may be configured in the form of an HDMV title or a Java title.

Thereafter, if the user selects a command for reproducing a specific title (e.g., Title #1), a specific playlist is reproduced according to a specific object command or program linked to the title (Title#1) in the object file of the file structure (a), and a specific clip “*.clip” or “*.m2ts” is reproduced by a playitem contained in the playlist.

If the selected title (Title #1) is determined to be the HDMV title, it is reproduced by a specific object “M-OBJ” contained in a single object file. Otherwise, if the selected title (Title #1) is determined to be the Java title, it is reproduced by a specific object “J-OBJ” contained in a Java program file (*.jar) of a Java directory (Java).

In association with the above-mentioned description, the above-mentioned index file is configured in the form of “index.bdj”, such that both the HDMV title and the Java title can be indexed. Otherwise, the above-mentioned index file may include a specific file for indexing only the HDMV title for the optical recording/reproducing device capable of reproducing only the HDMV title, such that it may also be configured in the form of two index files.

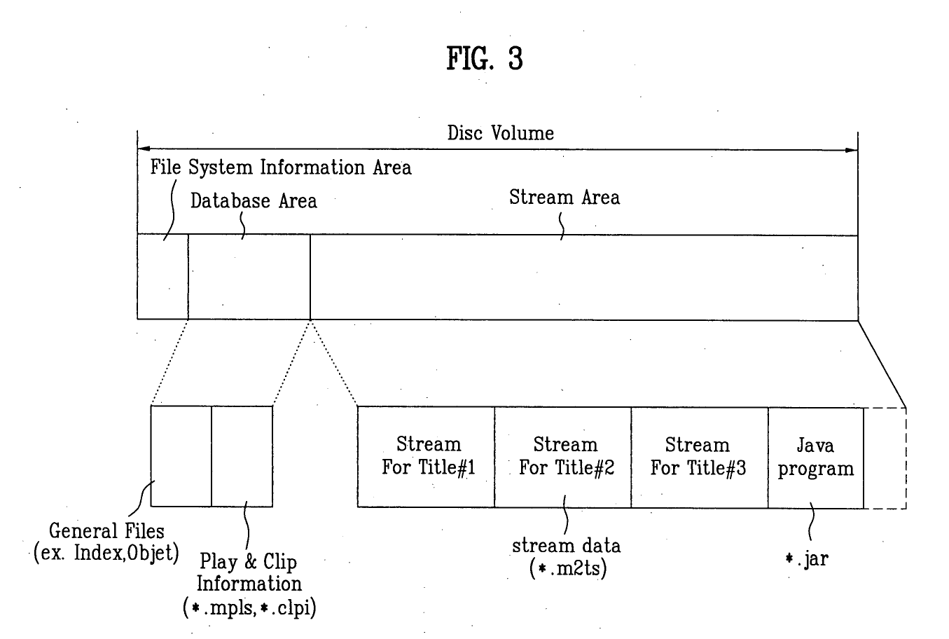

FIG. 3 is a structural diagram illustrating an exemplary disc structure for recording information associated with the file structure (a) in a disc. As shown in FIG. 3, from the viewpoint of an inner area of the disc, the above-mentioned disc structure sequentially includes a file system information area serving as system information for managing overall files, a database area for recording a playlist file and a clip-info file to reproduce a recorded stream (*.m2ts), and a stream area for recording a plurality of streams composed of audio data, video data, and graphic data, etc. Particularly, it should be noted that data recorded in the stream area of the disc may be determined to be data having different attributes as previously stated above.

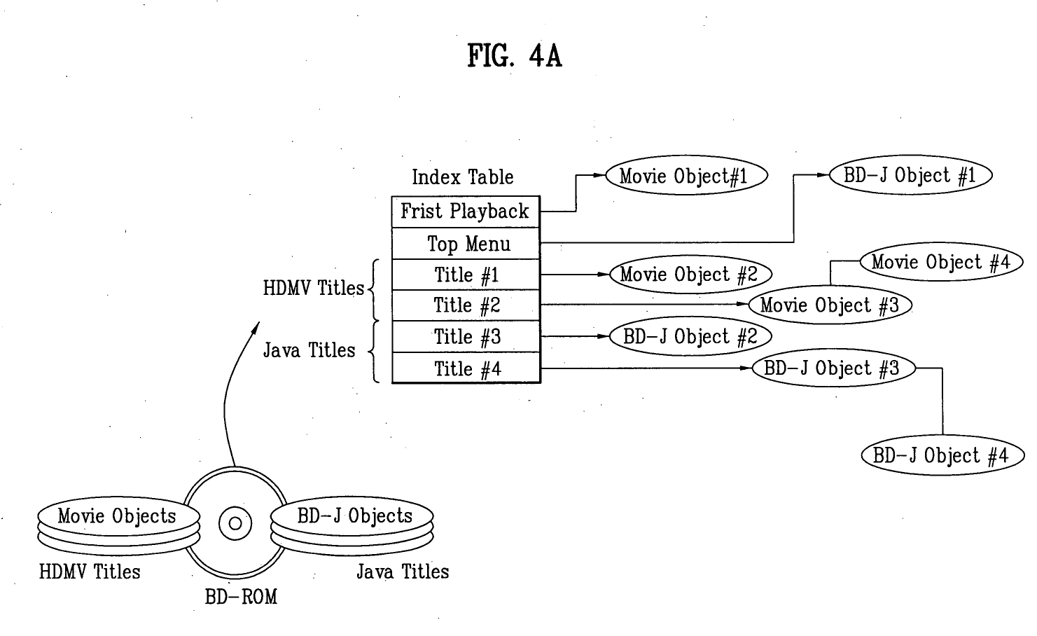

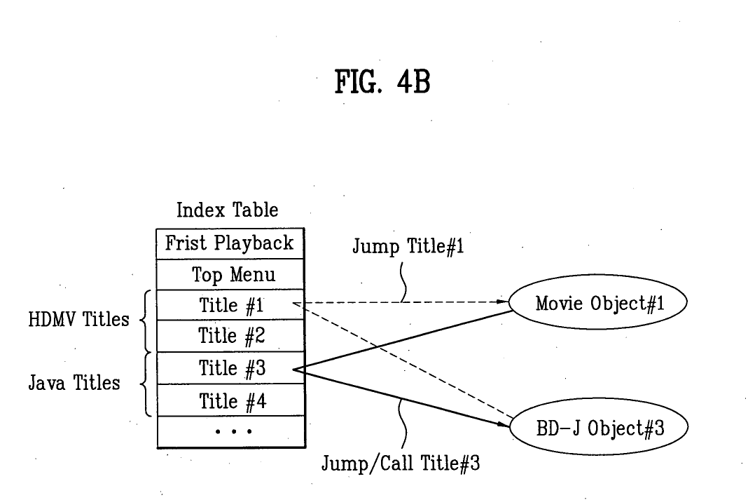

FIGS. 4A and 4B are conceptual diagrams illustrating reproduction of titles and a transition relationship between titles according to the present invention. Particularly, a reproduction disc according to the present invention is indicative of a full-mode disc including both the HDMV title and the Java title.

For example, provided that four titles are contained in a BD-ROM, titles #1 and #2 among the four titles are indicative of HDMV titles, and the remaining titles #3 and #4 are indicative of Java titles, individual titles are linked to a specific object file as described above.

In other words, the title #1 acting as the HDMV title is linked to a movie object “Movie-Object #2”, and the titles #2 acting as the HDMV title is linked to a movie object “Movie-Object #3”. The title #3 acting as the Java title is linked to a BDJ object “BDJ-Object #2”, and the titles #4 acting as the Java title is linked to a BDJ object “BDJ-Object #3”. For example, the first playback information “First Playback” contained in the index table can be linked to a movie object “Movie-Object #1”, and the top menu information “Top Menu” can be linked to a BDJ object “BDJ-Object #1”. In association with the above-mentioned description, the first playback information “First Playback” can be linked to the BDJ object, or the top menu information “Top Menu” can be linked to the movie object according to intentions of a manufacturer or author of the disc.

Also, it can be recognized that the movie object “Movie-Object #4” is linked to a movie object “Movie-Object #3”, and the BDJ object “BDJ-Object #4” is linked to a BDJ object “BDJ-Object #3”.

FIG. 4B is a conceptual diagram illustrating transition relationship between titles having different attributes when the titles contained in the disc shown in FIG. 4A are reproduced according to the present invention.

In association with the above-mentioned description, the movement- or transition-relationship between the HDMV title and the Java title according to the present invention has the following characteristics.

Firstly, direct transition between objects having different objects is not allowed. In other words, it can be recognized that transition between objects having the same attributes is available as shown in FIG. 4A. For example, the movie object “Movie-Object #3” can be transitioned to another movie object “Movie-Object #4”, and the BDJ object “BDJ-Object #3” can be transitioned to another BDK object “BDJ-Object #4”. However, direct transition between the movie object and the BDJ object having different attributes is not allowed, and only transition performed by title conversion is allowed.

Secondly, during the title conversion, title conversion from the HDMV title to the Java title is performed by “Jump” and “Call/Resume” commands. The “Jump” command terminates a current title during a title conversion process, and switches the current title to another title. The “Call” command suspends a current title during a title conversion process, and switches the current title to another title. The “Resume” command performs the return to the suspended title. In other words, the “Call” and “Resume” commands act as a pair of commands.

For example, if the title #1 (i.e., the HDMV title) is converted into the title #3 (i.e., the Java title) as denoted by solid lines in FIG. 4B, conversion operations based on the “Jump” and “Call” commands are all allowed.

Thirdly, during the title conversion, title conversion from the Java title to the HDMV title is performed by only the “Jump” command. For example, if the title #3 (i.e., the Java title) is converted into the title #1 (i.e., the HDMV title) as denoted by dotted lines in FIG. 4B, only the “Jump” command is allowed.

Since transition between titles having different attributes is allowed as stated above, a user can conveniently reproduce a variety of titles when using a specific disc. The reason why the title conversion from the Java title to the HDMV title is not allowed by the “Call” command is that a Java system does not include a register for suspending a current reproduction state. Therefore, if the Java system includes a backup register, the title conversion from the Java title to the HDMV title may be performed by the “Call” command.

FIGS. 5A and 5B are block diagrams illustrating an optical recording/reproducing device according to the present invention. Particularly, FIG. 5A is a block diagram illustrating the optical recording/reproducing device 10 according to the present invention, and FIG. 5B is a block diagram illustrating a reproduction processor 17 for reproducing data of a disc in which titles having different attributes are recorded according to the present invention.

The optical recording/reproducing device 10 according to the present invention will hereinafter be described with reference to FIG. 5A.

Referring to FIG. 5A, the optical recording/reproducing device 10 includes a pickup unit 11, a servo unit 14, a signal processor 13, a memory 15, and a microprocessor 16. The pickup unit 11 reads data recorded in a title record area of an optical disc, and reads management information including file information recorded in a management area. The servo unit 14 controls operations of the pickup unit 11. The signal processor 13 receives a reproduction signal from the pickup unit 11, restores the received reproduction signal to a desired signal value, or modulates a signal to be recorded into another signal recorded in the optical disc, such that it transmits the recovered or modulated result. The memory 15 stores information needed for reproducing data of the disc. The microprocessor 16 controls overall operations of the above-mentioned components contained in the optical recording/reproducing device 10. In association with the above-mentioned operations, the combination of the above-mentioned components 11, 14, 13, 15, and 16 is also called a recording/reproducing unit 20, and the recording/reproducing unit 20 can be manufactured in the form of a single product.

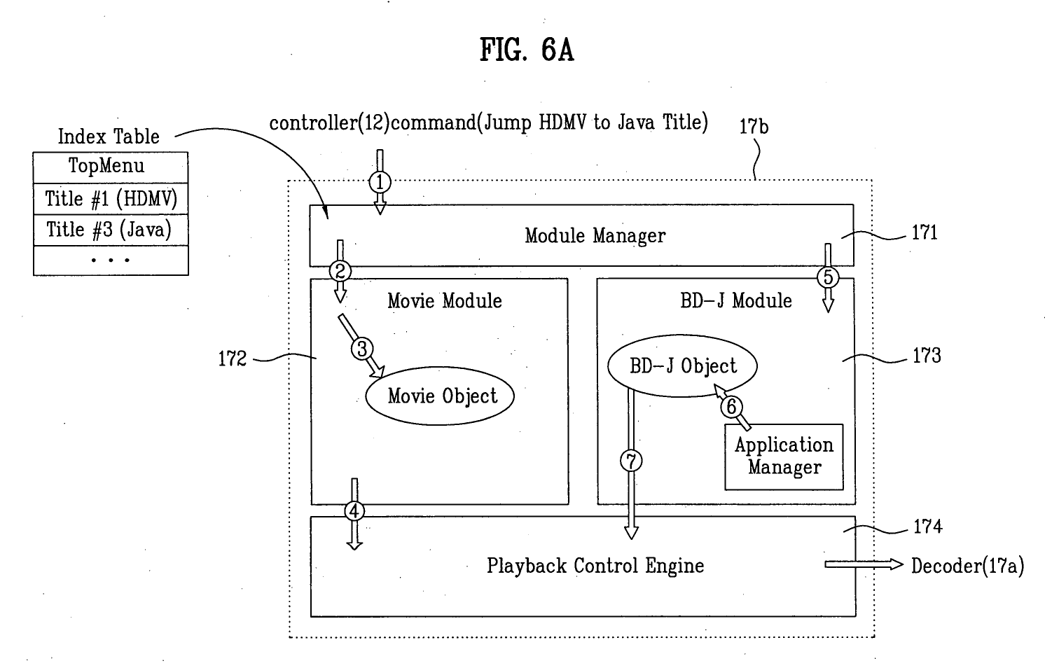

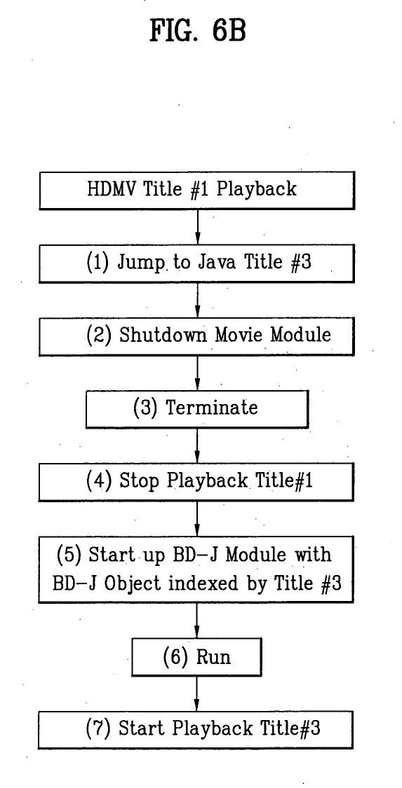

A controller 12 controls all the constituent components shown in FIG. 6A. Specifically, the controller 12 controls a reproduction command of a specific title or a title conversion command by interfacing with a user according to the present invention.

The reproduction processor 17 finally decodes output data upon receiving a control signal from the controller 12, and transmits the decoded result to the user. The reproduction processor 17 includes a decoder 17a for decoding AV signals; and a player model 17b for analyzing a command or program contained in the object and a user command received from the controller 12 in association with reproduction of the above-mentioned specific title, and determining a reproduction direction on the basis of the analyzed result.

However, it should be noted that the player model 17b may include the decoder 17a in some preferred embodiments, and the reproduction processor 17 may correspond to the player model shown in FIG. 5B.

An encoder 18 converts an input signal into a specific format signal (e.g., an MPEG2 transport stream) upon receiving a control signal from the controller 12, and transmits the converted result to the signal processor 13, such that it can record a desired signal in the optical disc.

FIG. 5B is a detailed block diagram of the reproduction processor 17 according to the present invention. The player model 17b includes a module manager 171, a movie module 172, a BDJ module 173, a playback control engine 174, and a presentation engine 175, and a detailed description thereof will hereinafter be described.

The movie module 172 acting as an additional reproduction process module capable of reproducing the HDMV title and the BDJ module 173 acting as an additional reproduction process module capable of reproducing the Java title are constructed independently of each other. The movie module 172 receives a command or program contained in the above-mentioned object “Movie-Object”, and the BDJ module 173 receives a command or program contained in the above-mentioned object “BDJ-Object”, such that the movie module 172 and the BDJ module 173 process the received command or program.

The movie module 172 includes a command processor 172a, and the BDJ module 173 includes an application manager 173a and a JAVA VM 173b, such that the movie module 172 and the BDJ module 173 are capable of receiving/processing the above-mentioned command.

The player model shown in FIG. 5B includes the module manager 171, the playback control engine 174, and the presentation engine 175. The module manager 171 transmits a user command to the movie module 172 and the BDJ module 173, and controls operations of the BDJ module 173. The playback control engine 174 analyzes playlist file content (associated with a static scenario) recorded in a disc upon receiving a reproduction command from the movie module 172 and the BDJ module 173, and performs a reproduction function on the basis of the analyzed result. The presentation engine 175 displays a specific stream managed by the playback control engine 174.

The playback control engine 174 includes a playback control function 174a for managing all the reproduction operations; a player status register (PSR) for indicating a reproduction environment or reproduction status of the player; and a player register 174b for storing general purpose register (GPR) information. The playback control function 174b may also be indicative of the playback control engine 174 as necessary.

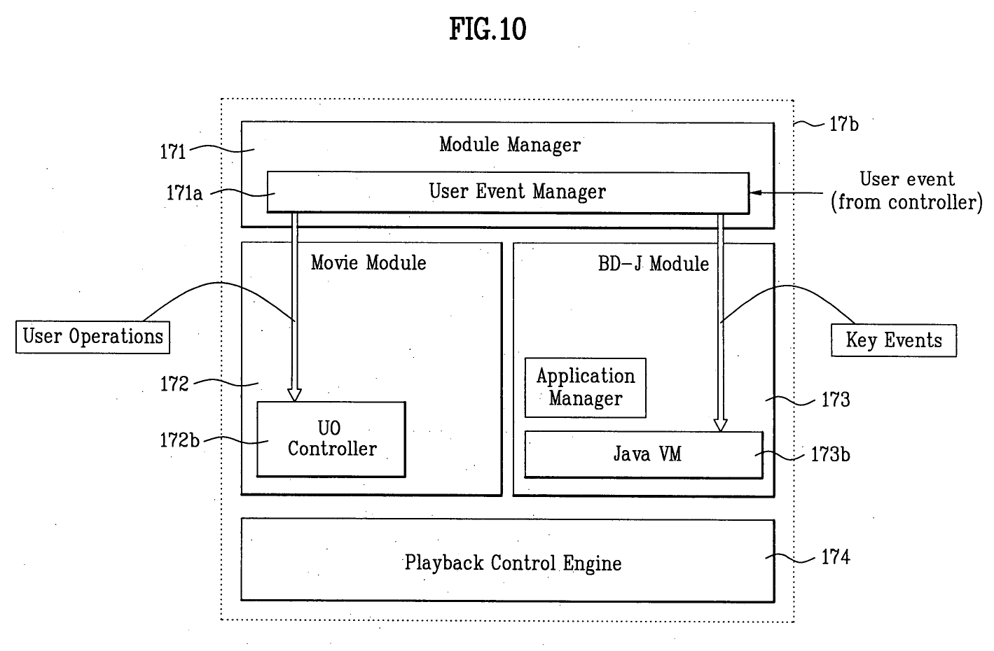

The module manager 171, the movie module 172, the BDJ module 173, and the playback control engine 174 contained in the player model shown in FIG. 10B can be processed by software. It is preferable that the above-mentioned components 171, 172, 173, and the 174 be processed by software instead of hardware. The presentation engine 175, the decoder 17a, and the graphic planes 17c and 17d are generally hardware based. Constituent components (e.g., 171, 172, 173, and 174) processed by software may be integrated in one unit, such that the integrated unit may be installed into the controller 12. Therefore, it should be noted that the above-mentioned components of the present invention be understood on the basis of their meanings, and are not limited to their implementation methods such as hardware or software implementation.

In association with the above-mentioned description, the characteristics of the player model are as follows.

Firstly, as stated above, the movie module 172 for the HDMV title and the BDJ module 173 for the Java title are configured independently of each other, and the two modules 172 and 173 cannot be executed at the same time. In more detail, the Java title cannot be reproduced when the HDMV title is reproduced, and the HDMV title cannot be reproduced when the Java title is reproduced.

Secondly, the HDMV title and the Java title receive user commands based on different schemes, respectively. The HDMV title and the Java title use different methods for performing individual user commands. There is needed a predetermined unit capable of receiving the user command, and transmitting the received user command to either the movie module 172 or the BDJ module 173. In this case, the above-mentioned operations are performed by the user event manager 171a contained in the module manager 171. For example, if the received command is determined to be a user command entered by a User Operation (UO), the user event manager 171a transmits the user command to a UO controller 172b contained in the movie module 172. Otherwise, if the received command is determined to be a user command entered by a key event, the user event manager 171a transmits the received user command to the Java VM 173b contained in the BDJ module 173. A detailed description thereof will be described with reference to FIG. 10.

Thirdly, one of the modules 172 and 173 manages the above-mentioned playback control engine 174. In more detail, when reproducing the HDMV title, the movie module 172 acts as a master of the playback control engine 174. When reproducing the Java title, the BDJ module 173 acts as a master of the playback control engine 174.

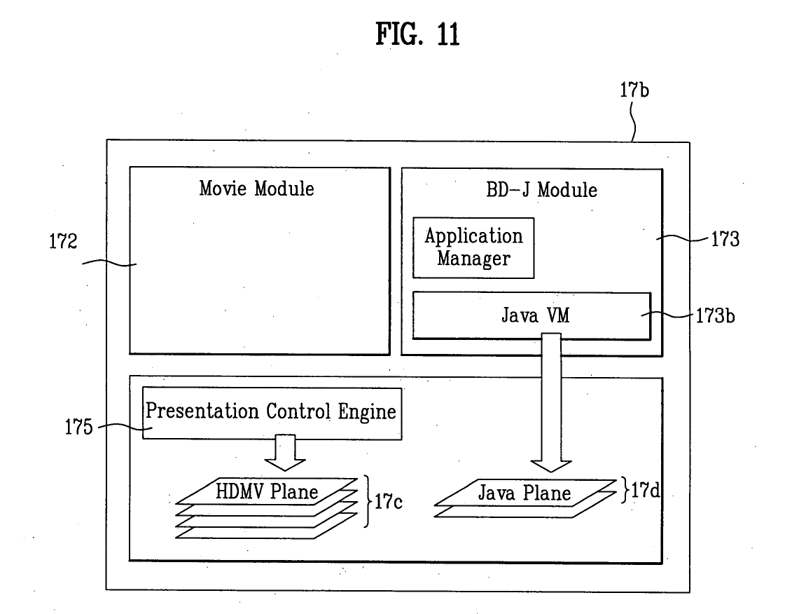

Fourthly, the graphic plane is independently managed. For example, the HDMV planes 17c control the presentation engine 175 to act as a master. The Java planes 17d control the Java VM 173b contained in the BDJ module 173 to as a master. A detailed description thereof will be described with reference to FIG. 11.

FIGS. 6A and 6B are conceptual diagrams illustrating operations of the player model shown in FIG. 5B when transition between titles having different attributes is performed as shown in FIG. 4B.

FIGS. 6A and 6B are conceptual diagrams illustrating operations when an HDMV title is transitioned to a Java title by a Jump command according to the present invention. In association with the above-mentioned player model 17b, some parts of the above-mentioned player model 17b are not associated with the preferred embodiment of the present invention, such that their detailed description will herein be omitted for the convenience of description.

The module manager 171 recognizes content data of the index table contained in the disc. In more detail, it can be recognized that the title #1 is indicative of the HDMV title, and the title #3 is indicative of the Java title as can be seen from the index table.

Therefore, if the player model receives a transition command equal to a Jump command for switching the title #1 acting as the HDMV title to the title #3 acting as the Java title from the controller 12 when reproducing the title #1 acting as the HDMV title at step \textcircled{1}, the module manager 171 commands the movie module 172 currently managing the title #1 to stop operations at step \textcircled{2}, commands the movie module 172 to terminate operations of a command of a specific object “Movie-Object” at step \textcircled{3}, and commands the movie module 172 to stop reproduction of the title #1 associated with the command at step \textcircled{4}. The movie module 172 stops its operation after the HDMV title is terminated. Thereafter, the module manager 171 drives the BDJ module 173 to execute the title #3 acting as the Java title at step \textcircled{5}, and a specific title #3 is reproduced according to a command or program of a specific object “BDJ-Object” linked to the title #3 at steps \textcircled{6}˜\textcircled{7}.

The player model shown in FIG. 5B does not execute titles having different attributes at the same time as described above. In order to perform transition (i.e., a Jump command) from the HDMV title to the Java title when the HDMV title is reproduced, it can be recognized that the BDJ module 173 must be driven after the movie module 172 is terminated.

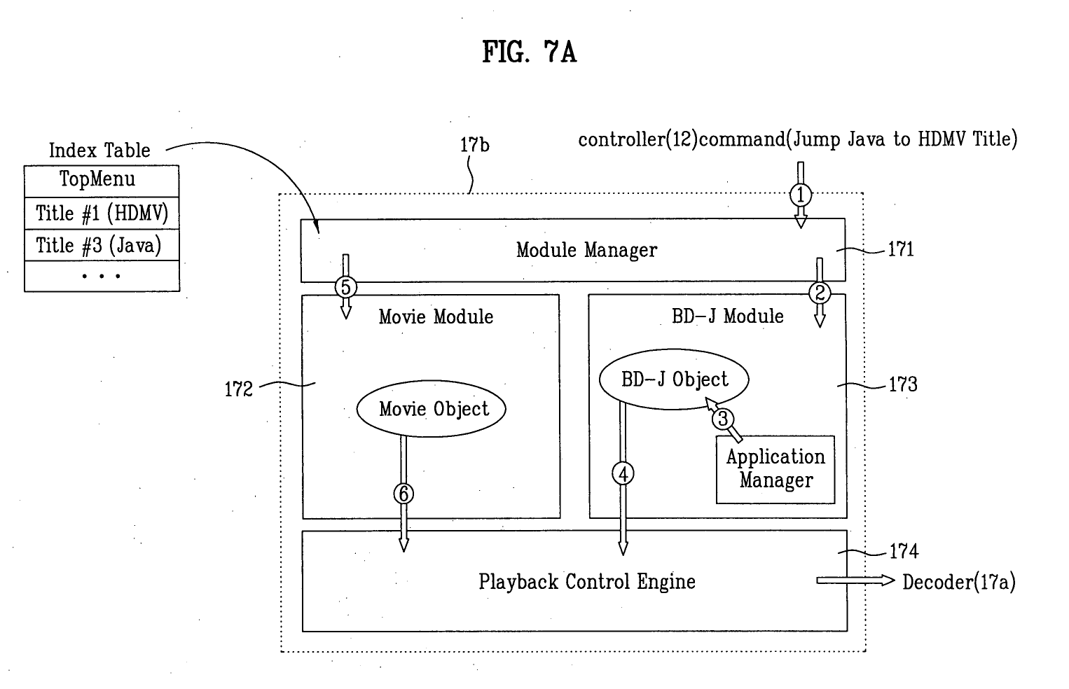

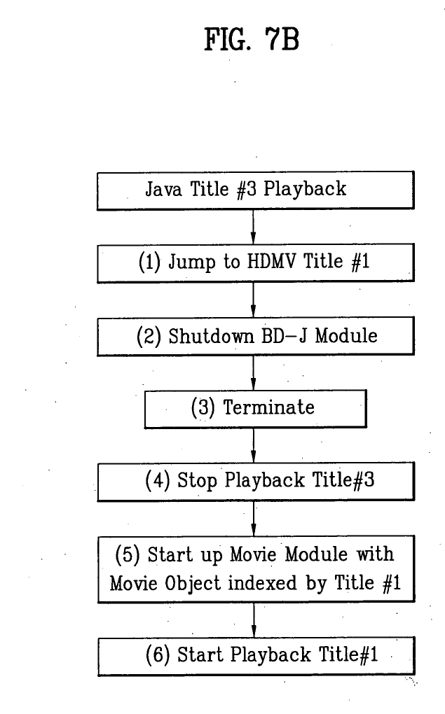

FIGS. 7A and 7B are conceptual diagrams illustrating operations when a Java title is transitioned to an HDMV title by a Jump command according to the present invention. In association with the above-mentioned player model shown in FIG. 5B, some parts of the above-mentioned player model are not associated with the preferred embodiment of the present invention, such that their detailed description will herein be omitted for the convenience of description.

The module manager 171 recognizes content data of the index table contained in the disc. In more detail, it can be recognized that the title #1 is indicative of the HDMV title, and the title #3 is indicative of the Java title as can be seen from the index table.

Therefore, if the player model receives a transition command equal to a Jump command for switching the title #3 acting as the Java title to the title #1 acting as the HDMV title from the controller 12 when reproducing the title #3 acting as the Java title at step \textcircled{1}, the module manager 171 commands the BDJ module 173 currently managing the title #3 to stop operations at step \textcircled{2}, commands the BDJ module 173 to stop operations of a program of a specific object “BDJ-Object” at step \textcircled{3}, and commands the BDJ module 173 to stop reproduction of the title #3 associated with the program at step \textcircled{4}. The BDJ module 173 stops its operation after the Java title is terminated. Thereafter, the module manager 171 drives the movie module 172 to execute the title #1 acting as the HDMV title at step \textcircled{5}, and a specific title #1 is reproduced according to a command of a specific object “Movie-Object” linked to the title #1 at step \textcircled{6}.

The player model 17b does not execute titles having different attributes at the same time as described above. In order to perform transition (i.e., a Jump command) from the Java title to the HDMV title when the Java title is reproduced, it can be recognized that the movie module 172 must be driven after the BDJ module 173 is terminated.

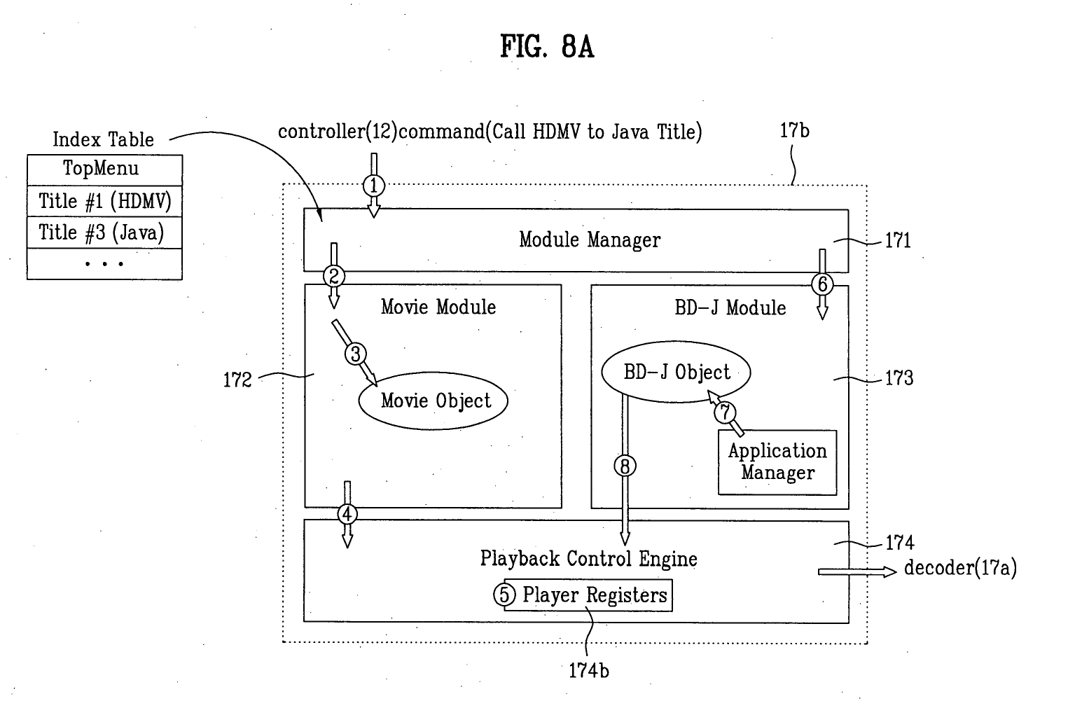

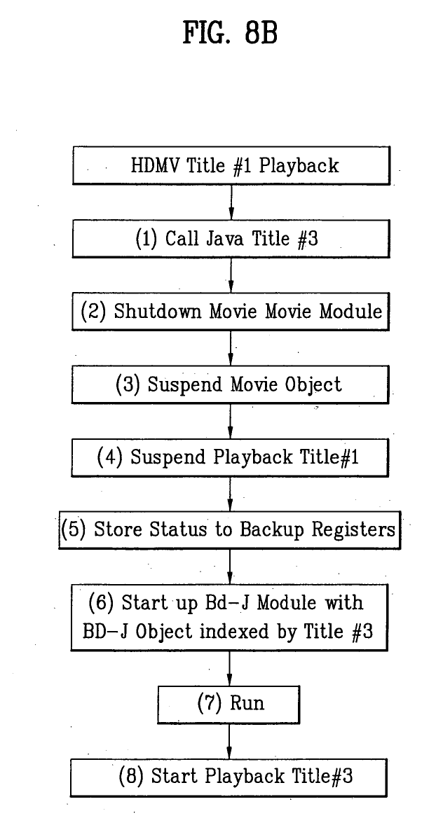

FIGS. 8A and 8B are conceptual diagrams illustrating operations when an HDMV title is transitioned to a Java title by a Call command according to the present invention. In association with the above-mentioned player model 17b, some parts of the above-mentioned player model 17b are not associated with the preferred embodiment of the present invention, such that their detailed description will herein be omitted for the convenience of description.

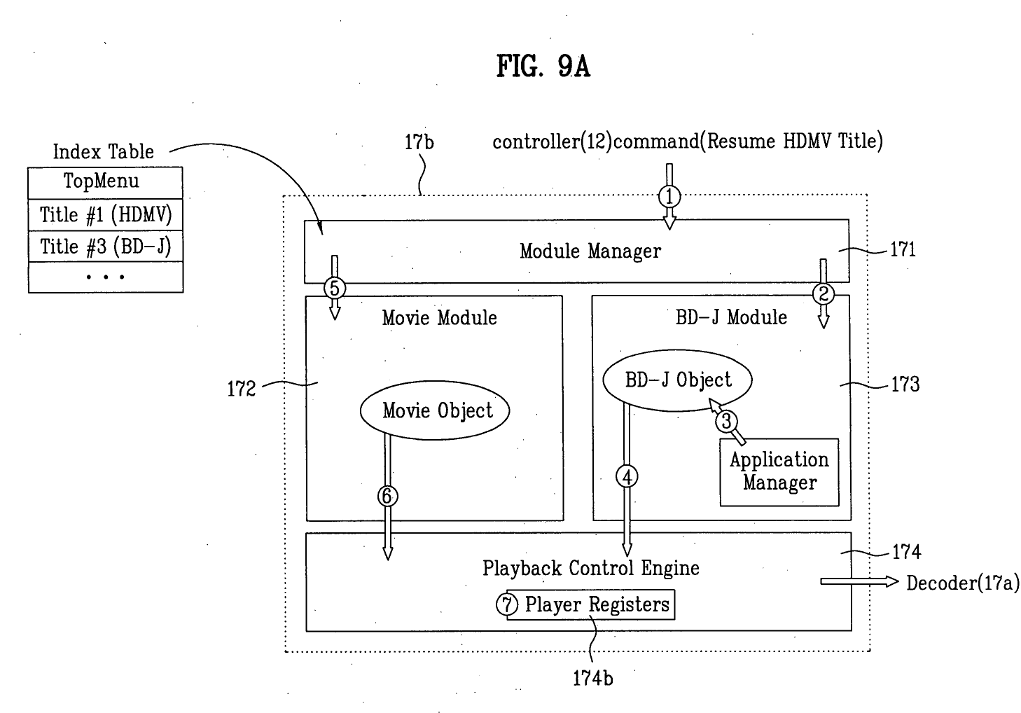

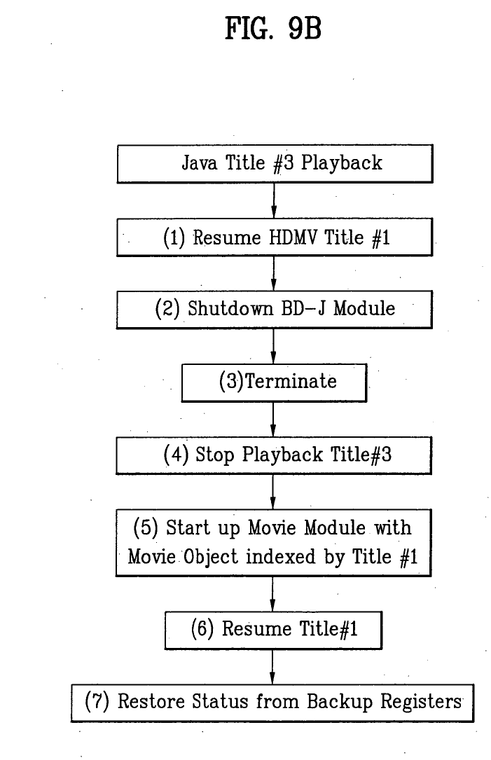

If the player model receives a transition command equal to a Call command for switching the title #1 acting as the HDMV title to the title #3 acting as the Java title from the controller 12 when reproducing the title #1 acting as the HDMV title at step \textcircled{1}, the module manager 171 commands the movie module 172 currently managing the title #1 to stop operations at step \textcircled{2}, commands the movie module 172 to suspend a command of a specific object “Movie-Object” at step \textcircled{3}, and commands the movie module 172 to suspend reproduction of the title #1 associated with the command at step \textcircled{4}. The movie module 172 stops its operation after the HDMV title is terminated. In more detail, since the “Call” command performs the return to the current position of the currently-reproduced title #1 differently from the aforementioned “Jump” command, all information of the currently-reproduced title #1 is not deleted, and reproduction state information (also called “playback state information”) is stored in the player registers 174b at step \textcircled{5}. In this case, the aforementioned return to the current position of the title #1 is performed by the “Resume” command, and a detailed description thereof will hereinafter be described with reference to FIGS. 9A and 9B.

The player model shown in FIG. 5B does not execute titles having different attributes at the same time as described above. In order to perform transition (i.e., a Call command) from the HDMV title to the Java title when the HDMV title is reproduced, the movie module 172 currently driven must be terminated.

Thereafter, the module manager 171 drives the BDJ module 173 to execute the title #3 acting as the Java title at step \textcircled{6}, and a specific title #3 is reproduced according to a program of a specific object “BDJ-Object” linked to the title #3 at steps \textcircled{7}˜\textcircled{8}.

FIGS. 9A and 9B are conceptual diagrams illustrating operations when the Java title is re-transitioned to the HDMV title by the “Resume” command after the HDMV title is transitioned to the Java title by the “Call” command shown in FIGS. 8A and 8B according to the present invention. Some parts of the above-mentioned player model shown in FIG. 5B are not associated with the preferred embodiment of the present invention, such that their detailed description will herein be omitted for the convenience of description.

If the player model receives a transition command equal to a “Resume” command for switching the title #3 acting as the Java title to the title #1 acting as the HDMV title from the controller 12 when reproducing the title #3 acting as the Java title at step \textcircled{1}, the module manager 171 commands the BDJ module 173 currently managing the title #3 to stop operations at step \textcircled{2}, commands the BDJ module 173 to stop operations of a program of a specific object “BDJ-Object” at step \textcircled{3}, and commands the BDJ module 173 to stop reproduction of the title #3 associated with the program at step \textcircled{4}. The BDJ module 173 stops its operation after the Java title is terminated. Thereafter, the module manager 171 drives the movie module 172 to execute the title #1 acting as the HDMV title at step \textcircled{5}, and a specific title #1 is reproduced according to a command of a specific object “Movie-Object” linked to the title #1 at step \textcircled{6}. The reproduction of the title #1 refers to reproduction state information pre-stored in the player registers 174b (See FIGS. 8A and 8B), and is performed by the value of a corresponding player register 174b on the basis of the aforementioned reproduction state information at step \textcircled{7}. It can be recognized that reproduction of the title #1 suspended by the “Call” command (See FIGS. 8A and 8B) restarts by the “Resume” command.

The player model shown in FIG. 5B does not execute titles having different attributes at the same time as described above. In order to perform transition from the Java title to the HDMV title by the “Resume” command when the Java title is reproduced, it can be recognized that the BDJ module 173 must be terminated.

FIG. 10 is a block diagram illustrating an apparatus for reproducing data from a recording medium, and more particularly, an apparatus for receiving/processing a user command according to the present invention. In more detail, FIG. 10 shows an example of the player model shown in FIG. 5B according to the present invention, and shows the second characteristics of the aforementioned player model shown in FIG. 5B.

In association with the second characteristics of above-mentioned player model shown in FIG. 5B, the module manager 171 includes the user event manager 171a for receiving a user command. Upon receiving the user command, the user event manager 171a determines whether the received user command is determined to be a user command entered by a User Operation (UO). If the user command is determined to be the user command entered by the User Operation (UO) for the HDMV title, the user event manager 171a transmits the user command to a UO controller 172b contained in the movie module 172, such that the UO controller 172b performs the user command. Otherwise, if the received command is determined to be a user command entered by a key event for the Java title, the user event manager 171a transmits the received user command to the Java VM 173b contained in the BDJ module 173, such that the Java VM 173b performs the user command.

In other words, the HDMV title mode and the Java title mode have different user command reception systems independently of each other. Therefore, if the above-mentioned different user commands are integratedly performed, there may arise user confusion. As a result, the user command for the HDMV title mode is executed by the movie module 172, and the user command for the Java title mode is executed by the BDJ module 173. The player model is characterized in that it additionally includes a user event manager 171a for determining whether the received user command is associated with the HDMV title mode or the Java title mode, and transmitting a corresponding user command to a corresponding module 172 or 173 according to the determined result.

FIG. 11 is a block diagram illustrating an apparatus for reproducing data from a recording medium, and more particularly, an apparatus for managing a graphic plan according to the present invention. In more detail, FIG. 11 shows another example of the aforementioned player model shown in FIG. 5B according to the present invention, and shows the fourth characteristics of the aforementioned player model shown in FIG. 5B.

In association with the above-mentioned description, the fourth characteristic of the player model shown in FIG. 5B relates to graphic plane management. For example, the HDMV planes 17c can be comprised of a video plane, a presentation plane, a graphic plane, an interactive graphic plane, and a text subtitle plane. The above-mentioned HDMV planes are managed by the presentation engine 175 acting as a master. The Java planes 17d can be comprised of Java graphic planes. The Java graphic planes use the Java VM 173b contained in the BDJ module 173 as a master, such that they are managed by the Java VM 173b acting as the master.

The HDMV planes 17c and the Java planes 17d can be partially shared with each other. Particularly, the interactive graphic plane contained in the HDMV planes 17c can share with the Java plane 17d as necessary.

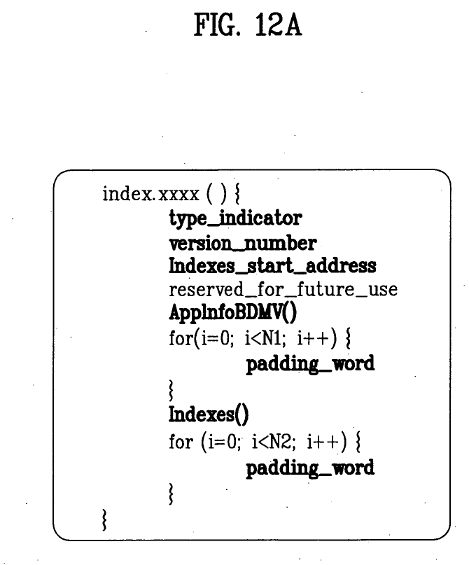

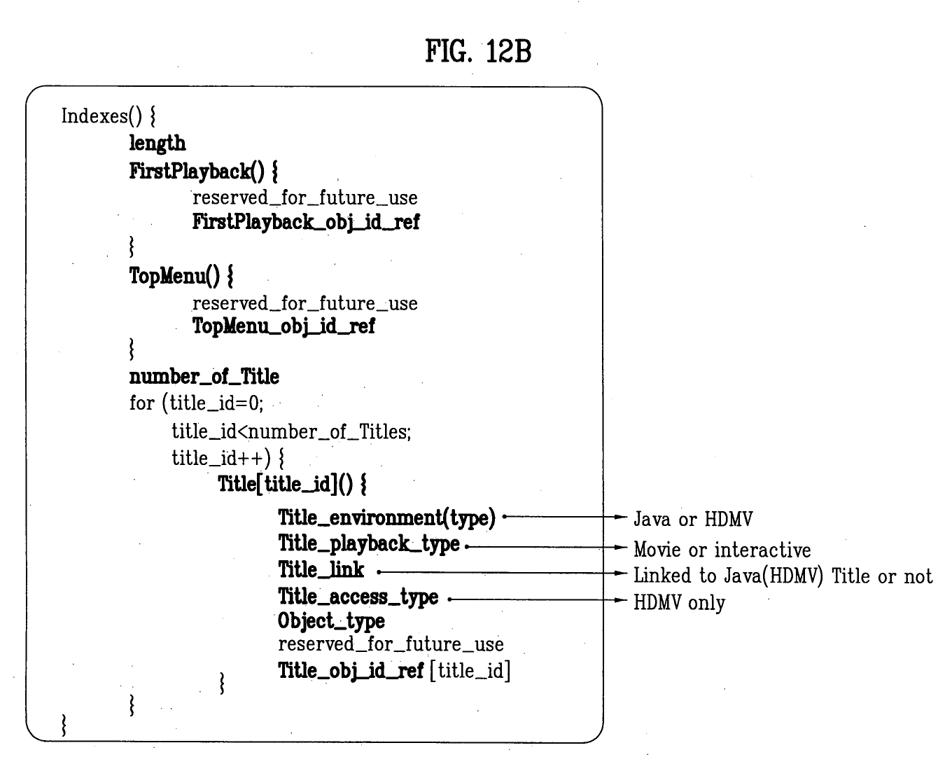

FIGS. 12A and 12B are structural diagrams illustrating syntax information of the aforementioned index file according to the present invention.

FIG. 12A shows a syntax associated with a header part of the index file (index.bdmv). For example, specific information capable of identifying an index file, for example, “INDX” character code, is recorded in the “type_indicator” field. Information indicative of version information of the index file is recorded in the “version_number” field. The “Indexes_start_address” field records location information indicative of a file start position of the “Indexes( )” field. The index file (index.bdmv) includes the “AppInfoBDMV ( )” field for providing general information associated with a disc author; and the “Indexes ( )” field for indexing contents recorded in the disc, and providing a user with the indexed contents. The “Indexes ( )” field associated with the present invention will hereinafter be described.

FIG. 12B shows a syntax of the “Indexes ( )” field contained in the index file (index.bdmv). In association with the above-mentioned description, the following description of FIG. 12B will be easily understood with reference to the operations and constructions shown in FIGS. 2, 4A, and 4B. In more detail, size information of the “Indexes( )” field is recorded in the “length” field. The “FirstPlayback( )” field includes “FirstPlayback_obj_id_ref” information for retrieving “obj_id” information capable of designating a specific object associated with a corresponding reproduction image, such that it can compulsorily display a first reproduction image when data of the disc is loaded. As stated above, the “FirstPlayback_obj_id_ref” information can designate both the movie object and the BDJ object.

The “TopMenu( )” field includes “TopMenu_obj_id_ref” information for retrieving the “obj_id” field capable of designating a specific object associated with a corresponding menu image, such that it can provide a menu image by the “Manu Call” command of the user. The aforementioned “TopMenu_obj_id_ref” information can designate both the movie object and the BDJ object.

Information indicative of the number of titles present in the index file is recorded in the “number_of_Title” field. Based on the above-mentioned number information of the titles, a plurality of the “Title( )” fields equal to the above-mentioned number information are present in the “number_of_Title” field. The “Title( )” field includes “Title_obj_id_ref” information for retrieving specific information “obj_id” contained in the object file including a reproduction command or program for reproducing a corresponding title, and also includes the following additional fields.

In more detail, the “Title_environment (type)” field indicative of title category information determines whether a corresponding title is an HDMV title or a Java title. The optical recording/reproducing device can pre-drive the player model shown in FIG. 5B to reproduce a title having a specific attribute by referring to the title classification information “Title_environment (type)”.

The “Title_playback_type” field is indicative of specific information capable of determining whether a corresponding title is a moving image title such as a movie or an interactive title such as menu information supplied to the user.

The “Title_link” field is indicative of specific information capable of displaying the presence or absence of other titles connected to a corresponding title. Particularly, the “Title_link” field is adapted to pre-check whether titles having different attributes are linked to each other, such that the player model shown in FIG. 5B can rapidly perform necessary operations.

The “Title_access_type” field is indicative of specific information for determining whether an operation for searching for a corresponding title can be performed. In more detail, the “Title_access_type” field is required for controlling operations of the User Operation (UO), and is needed for only the HDMV title.

The “Object_type” field is indicative of specific information for determining whether a corresponding title is an HDMV title or a Java title, and controls objects suitable for individual titles to be executed.

In order to designate the movie object “Movie Object”, the “Title_obj_id_ref” field includes specific information for designating the movie object contained in the “MovieObject.bdmv” file. In order to designate the Java object “BDJ object”, the “Title_obj_id_ref” field includes specific information for designating a Java program file, for example, a directory path for designating the “PPPPP.jar” file or the “QQQQQ.jar” file, and a file name. In addition, the “Title_obj_id_ref” field may include “application identifying” information or “Xlet identifying” information of the Java program file.

In association with the above-mentioned description, although FIG. 12B exemplarily shows only limited attribute information of individual titles, and it should noted that other title information other than the limited attribute information can also be contained in individual title categories as necessary.

As apparent from the above description, a recording medium, and a method and apparatus for reproducing data from the recording medium according to the present invention can record data having different attributes in a single recording medium, and can provide a user with the single recording medium. Also, the present invention can effectively manage the recording medium, resulting in greater convenience of use.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for reproducing data of a recording medium in which a first title and a second title having different attributes are recorded, the method comprising the steps of:
reproducing the first title using a first dedicated reproduction unit; and
performing transition of reproducing from the first title to the second title by stopping operations of the first dedicated reproduction units and starting operations of a second dedicated reproduction units.

2. The method according to claim 1, wherein the first title is an HDMV title, and the second title is a Java title.

3. The method according to claim 2, wherein the transition from one title having first attribute information to the other title having second attribute information different from the first attribute information is indicative of transition from the HDMV title to the Java title.

4. The method according to claim 3, wherein the transition from the HDMV title to the Java title is performed by a “Jump” command.

5. The method according to claim 3, wherein the transition from the HDMV title to the Java title is performed by a “Call” command.

6. The method according to claim 5, wherein:
after the HDMV title is transitioned to the Java title by the “Call” command, the Java title is re-transitioned to the HDMV title by a “Resume command”.

7. The method according to claim 2, wherein the transition from one title having first attribute information to the other title having second attribute information different from the first attribute information is indicative of transition from the Java title to the HDMV title.

8. The method according to claim 7, wherein the transition from the Java title to the HDMV title is performed by a “Jump” command.

9. The method according to claim 2, further comprising the steps of:
including an index file for managing the HDMV title and the Java title; and
providing a user with an image for title selection via the index file.

10. The method according to claim 9, wherein the index file is classified into a first index file including the HDMV title and the Java title, and a second index tile including only the HDMV title.

11. The method according to claim 9, wherein the index file includes title-environment information for classifying the HDMV title and the Java title.

12. The method according to claim 9, wherein the index file includes title link information between titles.

13. The method according to claim 9, wherein the index file includes object information including a command associated with specific title reproduction.

14. The method according to claim 13, wherein the object information for reproducing the HDMV title is indicative of a movie object.

15. The method according to claim 14, wherein:
a plurality of movie objects contained in the recording medium are contained in a single object file.

16. The method according to claim 13, wherein the object information for reproducing the Java title is indicative of a BDJ object.

17. The method according to claim 16, wherein the BDJ object contained in the recording medium is contained in a corresponding Java program file.

18. An apparatus for reproducing data of a recording medium in which an HDMV title and a Java title having different attributes are recorded, the apparatus comprising:
a playback control engine for reproducing a reproduction operation according to a static scenario recorded in the recording medium;
a movie module for controlling the playback control engine according to a command for reproducing the HDMV title;
a BDJ module for executing a Java program capable of reproducing the Java title, and controlling the playback control engine when a reproduction operation caused by the static scenario recorded in the recording medium is required; and
a module manager for receiving an external control command, and controlling operations of the movie module and the BDJ module.

19. The apparatus according to claim 18, wherein the static scenario recorded in the recording medium is managed by a playlist file and a clip-information file.

20. The apparatus according to claim 18, wherein the playback control engine includes:
a playback control function for performing reproduction operations; and
a plurality of player registers for storing reproduction state information.

21. The apparatus according to claim 18, wherein the module manager includes a user event manager for managing a user command.

22. The apparatus according to claim 21, wherein the user event manager receives a user command, and transmits the received user command to the movie module or the Java module according to characteristic information of the received user command.

23. The apparatus according to claim 22, wherein the movie module includes:
a User Operation (UO) controller for receiving a user command from the user event manager, and controlling the playback control engine using the received user command.

24. The apparatus according to claim 22, wherein the BDJ module includes:
a Java VM for receiving a user command from the user event manager, and reproducing a Java program or controlling the playback control engine using the received user command.

25. The apparatus according to claim 24, wherein the BDJ module further includes:
an application manager for classifying a plurality of applications contained in the Java program, and managing the classified applications.

26. The apparatus according to claim 18, further comprising:
a presentation engine for controlling a reproduction image of the HDMV title.

27. The apparatus according to claim 18, further comprising:
a decoder for decoding data of the HDMV title.

28. A recording medium comprising:
a title record area in which a first title and a second title having different attributes are recorded; and
a management file record area in which a first management file for reproducing the first title and a second management file for reproducing the second title are recorded,
wherein the management file record area stores information for classifying the first title and the second title.

29. The recording medium according to claim 28, wherein the management file record area further stores link information of the first title and the second title.
